(19) United States
(12) Patent Application Publication
(10) Pub. No.: US 2020/0177579 A1
(43) Pub. Date: Jun. 4, 2020

(54) Encrypted Blockchain Object Transfers Using Smart Contracts

(71) Applicant: Kountable, Inc., San Francisco, CA (US)

(72) Inventor: Craig M. Allen, Keller, TX (US)

(21) Appl. No.: 16/208,366

(22) Filed: Dec. 3, 2018

(51) Int. Cl. H04L 29/06; G06F 21/10; G06F 21/64; H04L 9/32; H04L 9/06; G06Q 40/04

(52) U.S. Cl. CPC H04L 63/0823; H04L 63/0428; G06F 21/10; G06F 21/64; H04L 2463/101; H04L 9/0637; H04L 63/123; G06Q 40/04; H04L 2209/38; H04L 9/3247

(57) ABSTRACT

Encrypted blockchain object transfers using smart contracts are provided herein. The present disclosure includes mechanisms for generating compliance certificates and their combined use with smart contracts in order to govern the transfer of ownership rights in objects between parties. Various data are encrypted and stored in a public ledger blockchain. Decryption keys are automatically released based on verified possession of compliance certificates in accordance with a smart contract. Possession of decryption keys allows for decryption and transfer of ownership rights.

### CROSS REFERENCE TO RELATED APPLICATIONS

This application relates to U.S. application Ser. No. 15/268,504, filed on Sep. 16, 2016, titled “SYSTEMS AND METHODS THAT UTILIZE BLOCKCHAIN DIGITAL CERTIFICATES FOR DATA TRANSACTIONS”, which is hereby incorporated by reference herein in its entirety, including all references and appendices cited therein.

### FIELD OF THE INVENTION

The present disclosure pertains to blockchain transactions, and more specifically, but not by way of limitation, to systems and methods that comprise mechanisms for generating compliance certificates and the use thereof to control access to smart contracts that govern the transfer of ownership rights for objects between parties. Various data, including the ownership rights are encrypted and stored in a public ledger blockchain. Decryption keys are released based on possession compliance certificates and possession of decryption keys facilitate automatic transfer of ownership rights for an object as provided in a smart contract.

### SUMMARY

A system of one or more computers can be configured to perform particular operations or actions by virtue of having software, firmware, hardware, or a combination of them installed on the system that in operation cause or causes the system to perform the actions. One or more computer programs can be configured to perform particular operations or actions by virtue of including instructions that, when executed by data processing apparatus, cause the apparatus to perform the actions. One general aspect includes a method, including: receiving a descriptive data and a digital signature for a first counterpart and a second counterpart; issuing one or more compliance certificates signed with a digital signature of a certificate issuer to each of the first counterpart and the second counterpart based on completion of a compliance evaluation using the descriptive data and the digital signature by the certificate issuer; and publishing the one or more compliance certificates to a public ledger blockchain in an encrypted format. Other embodiments of this aspect include corresponding computer systems, apparatus, and computer programs recorded on one or more computer storage devices, each configured to perform the actions of the methods.

Another general aspect the method includes: receiving an exchange and a digital signature for the second counterpart; searching the public ledger blockchain for the one or more compliance certificates of the second counterpart using the digital signature; verifying that a smart contract comprises conditions of transfer rights in an object of the first counterpart; publishing an encrypted transfer record in the public ledger blockchain that comprises an ownership transfer, a smart contract identifier, a wallet identifier for the second counterpart, and a rights issuer digital signature; and transmitting an ownership token and a primary decryption key for the encrypted transfer record to the second counterpart, the second counterpart using the primary decryption key and a secondary decryption key to decrypt the encrypted transfer record and obtain the rights in the object.

Another general aspect the method includes: receiving a request to transfer of the payload from a second counterpart; verifying the transfer of the payload using a smart contract; and providing the primary decryption key to the second counterpart when the conditions of transfer of the smart contract are met by the second counterpart.

One general aspect includes a system, including: a data broadcaster configured to: publish an encrypted transfer record to a public ledger blockchain, the encrypted transfer record comprising a secondary decryption key for a message stored in the public ledger blockchain; transmit an ownership token and a primary decryption key for the encrypted transfer record to a second counterpart if conditions of transfer of a smart contract referenced by the encrypted transfer record are satisfied; and a network of public listener devices each configured to: receive the encrypted transfer record as a byte stream of values; and store the encrypted transfer record in the public ledger blockchain. Other embodiments of this aspect include corresponding computer methods and computer programs recorded on one or more computer storage devices, each configured to perform the actions of the methods.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a diagrammatic illustration of a compliance certificate issuance process.

FIG. 2 is a diagrammatic illustration of an ownership rights transfer process.

FIG. 3 is a diagrammatic illustration of the broadcasting of encrypted transfer records to a public ledger blockchain and storage thereof.

FIG. 4 is a diagrammatic illustration of decryption of an encrypted transfer record, such as decrypting an encrypted message using primary and secondary decryption keys in order to affect a transfer of ownership rights.

FIG. 5 is a schematic diagram of an example system constructed for use in accordance with the present disclosure.

FIG. 6 is a flowchart of an example method of the present disclosure.

FIG. 7 is a flowchart of another example method of the present disclosure.

FIG. 8 is a schematic diagram of an example computing system that may be used to implement embodiments disclosed in accordance with the present disclosure.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The present disclosure is directed to systems and methods that facilitate the transfer of ownership rights for object between parties. These systems and method use information published to a public ledger blockchain in view of a smart contract in order to store and release information. In general, the object can include any digital object such as a record, a digital financial instrument, medical record, and other similar content. Generally, the present disclosure contemplates the use of compliance certificates to indicate whether a counterpart (e.g., party) to a transaction is an authorized party. What constitutes authorization may depend on the context of the object being transferred. For example, when the object is a financial instrument or payment authorization may include a know-your-customer (KYC) process or anti-money laundering (AML) check. If the object is a medical record, the authorization may include determining if a counterpart is a covered entity or other similarly situated party that is allowed to possess or view the medical record. In sum, the authorization process used will be situation and context dependent.

One of the uses of a public ledger blockchain of encrypted data stacks is the issuance of compliance certificates. For example, once a counterpart has passed a KYC/AML checks, the systems and methods here can encrypt a data stack (e.g., encrypted transfer record) associated with KYC/AML process, along with compliance certificates (digitally signed by a certification issuer and dated). A compliance certificate (i.e., certifying that the entity has passed a KYC or other similar process and is approved to engage in transactions), if it is not expired, is all that is required to transact with that counterpart. If the counterpart presents one or more compliance certificates a specified range of activities may be approved. As such, compliance certificate(s) can be presented to fulfill a requirement of a smart contract for ownership transfer of an object or the release of information such as a decryption key that allows a counterpart to gain access to the ownership right.

This allows an entity to transact transfers of ownership in a relatively anonymous (but legitimate) fashion. In one embodiment a counterpart would own one half of a decryption token, referred to as a primary portion of a decryption token/key, and the systems configured herein would retain a secondary portion of the decryption token/key. The counterpart owning the primary portion of the decryption token could transfer (via smart contract) their portion of the decryption token to whomever they wanted as long as the receiving counterpart fulfills any requirements for transfer established in the smart contract.

The system would then release the primary portion of the decryption key (provided the final owner also fulfills those requirements). The system would automatically release the secondary decryption key (or include it in an encrypted transfer record stored in the blockchain) so that the data stack could be decrypted and viewed if requirements are fulfilled. One of the requirements, in one embodiment, is that the transaction history for any token is complete to origin, with every transaction providing proof that the smart contract requirements are fulfilled.

In some embodiments, more than one type of compliance certificate may be required to perform a transaction such as a rights transfer between two counterparts. Compliance certificates are generated and digitally signed by a certifying entity. For example, a certifying entity can include a bank or financial institution. In general, the certifying entity is responsible for performing authorizations of individuals or entities and generating one or more types of compliance certificates.

In some embodiments, both counterparts to a transfer of rights in an object are required to possess one or more compliance certificates. These compliance certificates are stored in a public ledger blockchain in association with the respective digital signatures of the counterparts and any signatures from the certificate issuers.

The systems and methods herein authenticate counterparts by searching the public ledger blockchain for required compliance certificates using the respective digital signatures of both counterparts. In some instances, the compliance certificates required of each counterpart are stored in a smart contract. In general, a smart contract as disclosed herein comprises conditions of transfer of rights of the object in question.

When a receiving party or counterpart has been authorized, the systems and methods herein authorize transfer of the object based on the conditions of transfer in the smart contract.

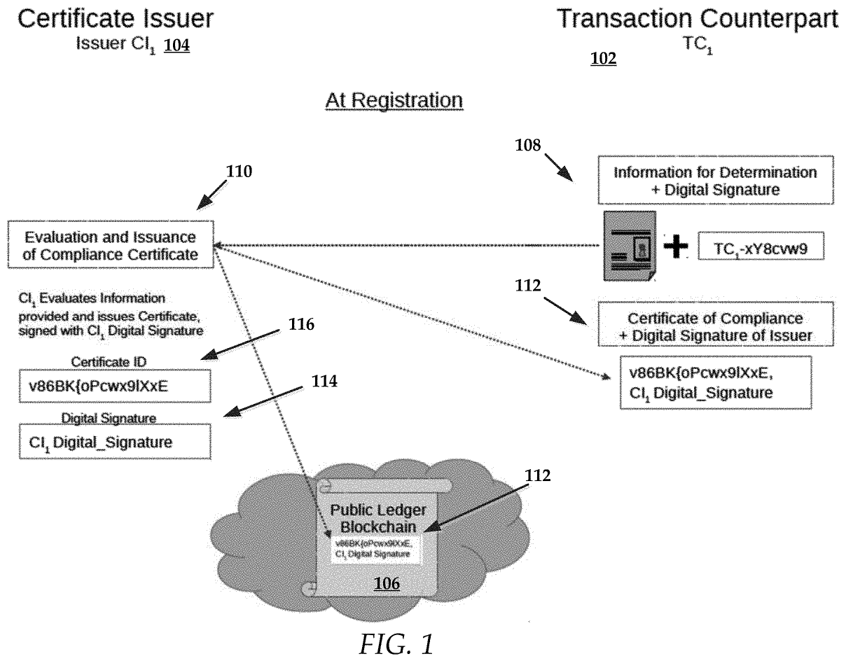

In more detail, FIG. 1 illustrates an example method for issuing a compliance certificate to a counterpart. Generally, this process is referred to as a registration of counterparts. The method involves two parties, a counterpart 102 and a certificate issuer 104. The counterpart 102 represented can be either the first or second counterpart.

For context, the methods disclosed herein are configured to affect transfer of ownership rights in an object between two parties, referred to herein as counterparts. Thus, there are at least two counterparts to each ownership rights transfer, a first counterpart and a second counterpart. The first counterpart owns the object as well as the ownership rights which are intended to be transferred to the second counterpart.

In some embodiments, the certificate issuer 104 will receive descriptive information and a digital signature from the counterpart 102. This can be embodied as a request message 108 for a compliance certificate. The descriptive information requested from the counterpart 102 includes data which are required from the certificate issuer 104 in order to perform a requisite search regarding the counterpart 102, such as KYC, AML, or other similar search. Again, the descriptive information requested can be tailored to the needs of the certificate issuer 104 in view of the type(s) of checks being performed. The certificate issuer 104 will perform required evaluation(s) in process 110 and if approved by the certificate issuer 104, the certificate issuer 104 will issue a compliance certificate 112. It will be understood that in some instance more than one compliance certificate can be issued to a counterpart and each may require different types of descriptive information about the counterpart.

It will be further understood a second counterpart to any rights transfer will also undergo the same type(s) of analysis by the certificate issuer 104 in order to provide the second counterpart with one or more compliance certificates as well. The issuance of compliance certificates prior to processing a transfer request using a smart contract allows a rights issuer, discussed in greater detail herein, to rely on the compliance certificates with the understanding that the counterparts to a proposed rights transfer have been previously vetted by a certificate issuer.

The certificate issuer 104 can sign each compliance certificate with a certificate issuer digital signature 114 in some embodiments. In one or more embodiments, the compliance certificate signed with the certificate issuer digital signature is transmitted back to the counterpart 102. Each compliance certificate is provided with a unique compliance certificate identifier 116.

Also, the compliance certificate signed with the certificate issuer digital signature is published to a public ledger blockchain 106 for storage thereon. Again, this process can be repeated for an entity (e.g., counterpart) that desires to perform transactions and transfer object rights in accordance with embodiments of the present disclosure.

In general, transfer transactions are used to transfer ownership rights to an object. The object can include any digital or physical object such as a financial instrument like a title or deed. As noted above, in other use cases the object can comprise a document such as an electronic health record, or other digital document.

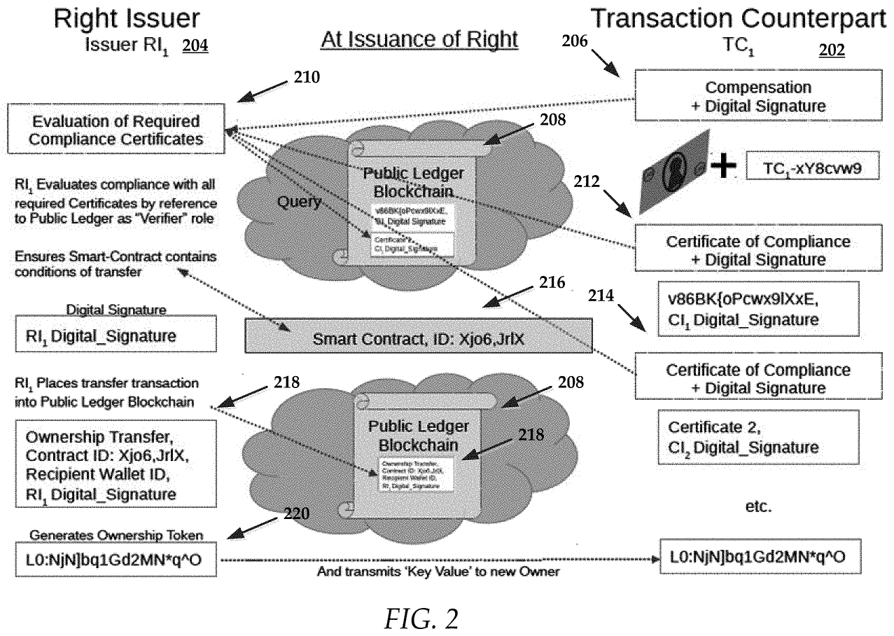

FIG. 2 diagrammatically illustrates the transfer of an ownership right in an object to a second counterpart 202 in accordance with the present disclosure. In general, transfer rights are initially created when the asset in question is created and mapped to a particular rights allocation framework. For example, an ownership right in an object such as a bitcoin address is created when the bitcoin is purchased. Ownership for that bitcoin address is stored as a record in a blockchain using the rights allocation framework disclosed herein. Transfer of rights to that object is also defined by the rights allocation frameworks disclosed herein (e.g. the systems and methods of the present disclosure).

Generally, FIG. 2 collectively illustrates both the issuance and transfer of a right in an object. FIG. 2 generally illustrates the initial issuance of the right to a qualifying party which includes two qualification certificates (plus providing compensation). The illustration equally applies to the transfer from some subsequent owner to a succeeding owner. The subsequent owner would also need to provide the two qualification certificates (and presumably provide some compensation).

For context, a party desiring to transfer a right related to an object is referred to as a first counterpart. An entity that can issue the right to transfer that object is referred to as a rights issuer 204. In some embodiments, the certificate issuer and the rights issuer are embodied in the same system, while in other instances two different systems each assume a role of certificate issuer or rights issuer.

Initially, the counterpart 202 indicates an exchange 206 and a digital signature as a package. To be sure, the exchange 206 refers to what is provided in exchange for the ownership rights of object of interest. For example, the exchange comprises money that is provided in order to cause a transfer in ownership rights to an object. Again, an example would include money in exchange for a title to a vehicle.

The rights issuer 204 receives the digital signature from the counterpart 202 and uses the digital signature to query a public ledger blockchain 208 (e.g., the public ledger blockchain 106 of FIG. 1) for one or more compliance certificates for the counterpart 202. The uppermost illustration of the public ledger blockchain 208 indicates the query process, whereas the lower illustration of the public ledger blockchain 208 illustrates a publishing process disclosed below.

These one or more compliance certificates are required to be evaluated for the counterpart 202 before a transaction transfer of ownership rights can be published as illustrated in process 210. In this instance, the rights issuer 204 locates a compliance certificate in the public ledger blockchain 208. Other possible compliance certificates may be required such as compliance certificates 212 and 214.

The rights issuer 204 will also evaluate a smart contract 216 to determine if compliance certificates meet the conditions of transfer of the rights in an object. These condition can also include a sufficiency of the exchange 206 offered (i.e., is the exchange enough to compensate for the ownership transfer). In some embodiments, the rights issuer 204 or a certificate issuer can dictate the conditions of transfer. A part of the conditions of transfer can also be established by the counterpart who is the current rightful owner of the object or the ownership rights associated therewith.

If the conditions of the smart contract 216 are approved and the counterpart 202 has the required compliance certificates, the rights issuer 204 will publish a transfer transaction 218 into the public ledger blockchain 208. The transfer transaction 218 generally comprises an ownership transfer of the object, a smart contract identifier, a recipient wallet identifier, and a digital signature of the rights issuer 204. The recipient wallet identifier indicates a location to which ownership rights defined in the transfer transaction are to be transferred.

In some embodiments, the rights issuer 204 can generate a new ownership token 220 when a transfer of ownership is completed to a new rights owner using the transfer transaction and its associated smart contract disclosed herein. A primary portion of a decryption key is also provided to the new owner in some embodiments. It will be understood that some embodiments include the use of encryption/decryption and the sharing or dissemination of encryption key(s) within the context of transferring an object. The use of encryption key(s), either one or two, for releasing an object or gaining access thereto is not required and that some embodiments contemplate the transfer of an ownership right in an object that neither requires or implements encryption or decryption. But, if the right being transferred is an information access right, then a decryption key could comprise part of what is transferred between parties. To be sure, there is a right to access the decryption key, just as there is a right to access the collections that is transferred, in some embodiments.

In some embodiments, the transfer transaction 218 is encrypted into a checksum prior to publishing to the public ledger blockchain 208. The encrypted version is referred to as an encrypted transfer record. Thus, the publicly distributed transaction record in the public ledger blockchain 208 (which is encrypted and placed for public access, with viewing rights, as authorized) is not what is placed into the public ledger blockchain 208. Instead, a checksum of an entire encrypted transaction file (i.e., multiple records) is placed into the public ledger blockchain 208 so that the public ledger blockchain 208 provides irrefutable proof of a state of transaction data in transfer transaction 218, which is verified as at the date of checksum insertion.

The encrypted version of the transfer transaction 218 can be decrypted using a decryption key. In some instances, the decryption key comprises two decryption keys or a single key that is split into two parts. A secondary part of the decryption key can be published to the public ledger blockchain 208, whereas a primary part of the decryption key is provided to a current owner of the object referenced in the transfer transaction 218.

In some embodiments, ownership of various decryption keys is placed into the public ledger blockchain 208. In one embodiment suppose there are ten different stacks of data in the public ledger blockchain 208 and separate keys are distributed for each of the data stacks (fixed or variable length records or blobs in a blockchain). If one of those stacks comprises relatively public information (e.g., basic trade description), only minimal restrictions are required for who can present that key. For example, a party presents a view token for the stack, but is not otherwise credentialed. When those minimal restrictions are fulfilled, a needed decryption token is provided. So, with two tokens, the secondary decryption token and the ownership token (e.g., primary token), the information in that data stack can be easily viewed. To be sure, the use of encryption is contemplated in some embodiments, but all embodiments need not utilized single or dual encryption keys.

Some other data stacks might have more restrictive requirements to fulfill, such as specific compliance certificates and these requirements might allow only a small set of parties to access the data stack. The transfer of ownership keys is governed by smart contracts that specify requirements to complete transfer. For example, a new owner must have and present the requirements for viewership prior to transfer of key ownership.

As noted above, a smart contract comprises requirements for disseminating decryption keys. These requirements are embedded within a smart contract in one embodiment. In other words, automatic presentation of electronic proof such as tokens and/or compliance certificates forces a smart contract to release the primary part an encryption/decryption key so that both required keys can automatically decrypt the information in the data stack.

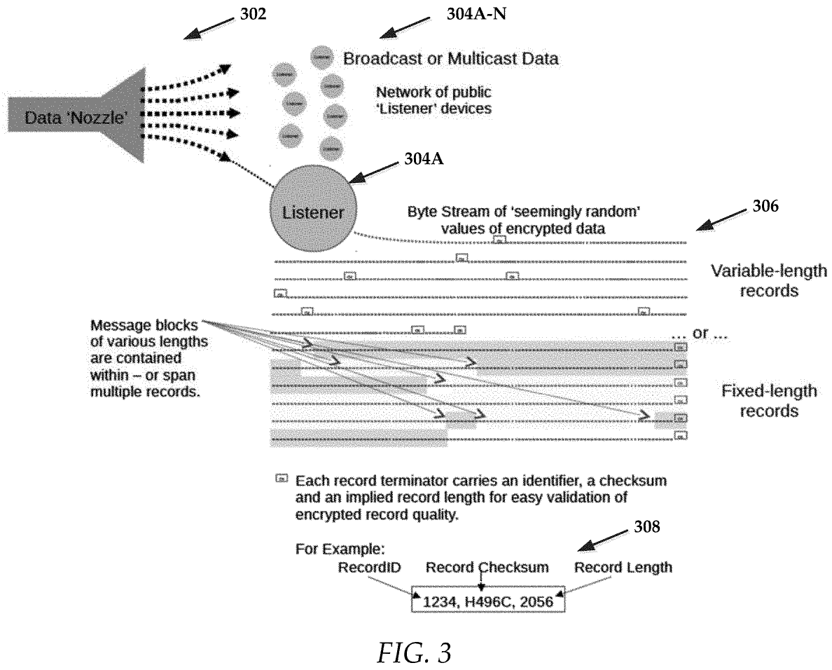

FIG. 3 illustrates a system and process for publishing encrypted data to a public ledger blockchain. The system generally comprises a data broadcaster 302, referred to as data nozzle, and a network of public listener devices 304A-N.

A public listener could be any suitable computing device managing a publicly available data set, with at least one specified at system creation. A data broadcaster is any point-to-point or multicast system (even a public website) that publishes data such as a blockchain ledger disclosed herein.

The data broadcaster 302 broadcasts a byte stream of values of encrypted data, such as encrypted versions of transfer transactions disclosed above. These stacks of data are comprised of many transfer transactions that are stored as either variable-length records or fixed-length records. In fixed-length records, message blocks of various lengths are contained within, or span, multiple records. An example public listener device 304A receives the byte stream of values of encrypted data and stores the byte stream in either the public ledger blockchain 306 as variable-length records or fixed-length records. Each record terminator, such as terminator 308 carries a record identifier, a checksum (generated from a transfer transaction data set), and a record length. An example record terminator is illustrated for reference in FIG. 3. It will be understood that the record length is utilized for quick validation of encrypted transfer record quality.

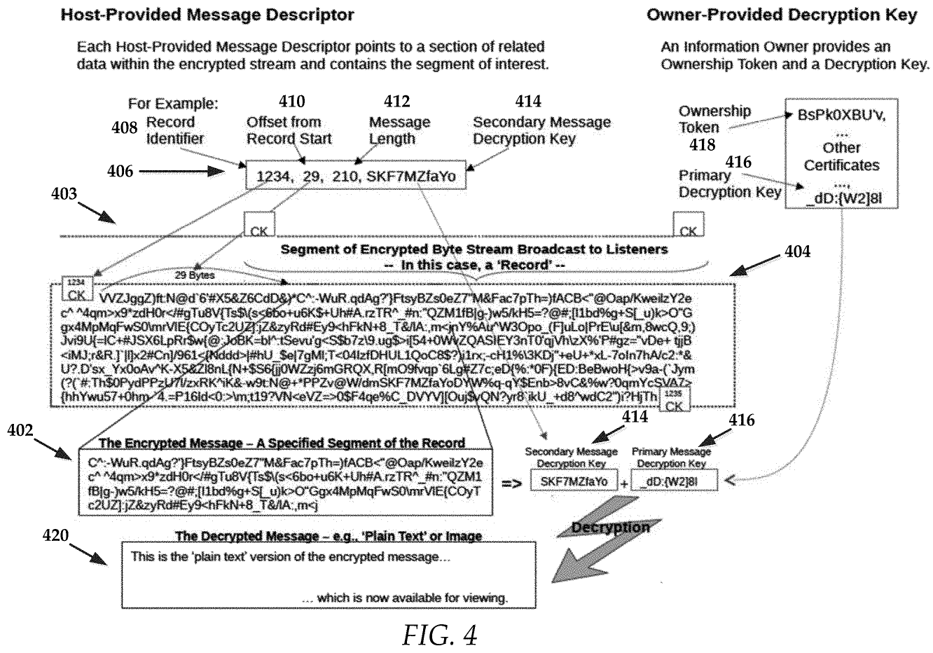

FIG. 4 diagrammatically illustrates a process of decrypting an encrypted transfer record 402 stored in a portion of a public ledger blockchain 404. In more detail, the encrypted transfer record 402 is included in a byte stream 403. The encrypted transfer record 402 is an encrypted version of data required to transfer ownership of a transfer transaction (such as the transfer transaction 218 of FIG. 2). As noted above, for security, the transfer transaction is encrypted into a checksum value before publishing to the public ledger blockchain.

The encrypted transfer record 402 can include any combination of one or more compliance certificates, digital signatures, transfer transaction data, a payload or object (if digital), and so forth. In some embodiments, a host-provided message descriptor 406 is generated that points to a section of related data within an encrypted stream and contains a segment of interest, referred to as a stack.

The host originating the host-provided message descriptor is the same as the entity that broadcasts data as disclosed herein, although access to the host-provided message descriptor 406 is provided when a current owner of a digital viewing right proves via smart contract that they are eligible to possess or receive the right. For example, if a view right is owned by a party, P1, implying that P1 has the ownership token for certain data, and then that same party, P1, seeks to exercise that view right, then P1 presents the ownership token, together with the requisite credentials, and the ‘host’ (or system that produces the broadcast data) will transmit to P1 the message containing the secondary message decryption key.

The host-provided message descriptor 406 comprises a record identifier 408, an offset from record start value 410, a message length value 412, and a secondary decryption key 414. A current owner (counterpart) holds a primary decryption key 416 and an ownership token 418. As noted above, the encryption/decryption key used to encrypt the transfer transaction is comprised of two parts, the primary decryption key 416 and the secondary decryption key 414. Thus, both the primary decryption key 416 and the secondary decryption key 414 are needed in order to decrypt the encrypted transfer record.

In some embodiments, a host-provided message descriptor 406 points to a section of related data an encrypted stream and comprises a segment of interest. Namely, the offset from record start value 410 identifies a placement of a beginning character of the encrypted transfer record 402 and the message length value 412 indicates a number of characters after the offset from record start value 410 that are included in the encrypted transfer record 402.

As one of ordinary skill in the arts of decryption and brute-force methods of breaking encryption/decryption codes would appreciate, having record terminators facilitates the ‘breaking’ of the intended encryption. Messages utilized herein include random record lengths with unpredictable message termination (unpredictable to those that do not possess the actual record length information) with additional, follow-on random information (or perceived random if the encryption key for the following section is different), make the brute-force breaking of the encryption orders of magnitude more difficult. If encryption keys change unexpectedly in a body of encrypted information, then factoring out guesses for decryption keys is very difficult. The record terminators are implemented for the purpose of allowing easy hash-key verification of the data originally as originally written. An immutable record with hash-key verification of a 1026 byte record is an easy task. It is easy to prove that the whole record has not been modified. If that record consists of some number of random (or seemingly random) bytes that precede the message of interest, and some other random number of bytes that follow the message of interest, then brute force methods for ‘guessing’ the correct decryption key are foiled by not knowing where the target message begins and where it ends within that message.

If the counterpart requesting transfer meets the conditions of transfer included in the smart contract linked to the encrypted transfer record 402 (linked by the record identifier), the primary decryption key 416 is provided to the counterpart who already possesses the secondary decryption key 414 because they have access to view the encrypted transfer record 402 and the secondary decryption key 414 is listed in the encrypted transfer record 402.

As noted above, the release of the primary decryption key 416 occurs automatically when the second counterpart (party requesting transfer of the object) meets the conditions of transfer included in the smart contract.

Using the primary decryption key 416 and the secondary decryption key 414, the second counterpart can decrypt the encrypted transfer record 402 and receive a decrypted message 420. This decrypted message 420 comprises the object or content that was the subject of the transfer transaction. That is, ownership of the object or content is transferred from the first counterpart to the second counterpart.

With respect to the use of primary and secondary encryption/decryption keys, the use of a smart contract to control transfer of an ownership right in an object is not limited to embodiments that require dissemination of primary and/or secondary decryption keys. As is apparent in following the logic described relating to FIG. 2 (see elements 202-216), a secondary decryption key is not an essential element of ownership transfer. Where a secondary encryption key is beneficial, such as with message content assets, then it can be employed. Encryption keys are an extension of the smart-contract concept generally disclosed herein and is useful in instances where the object is encrypted for storage as a checksum or when the content of the object itself is encrypted.

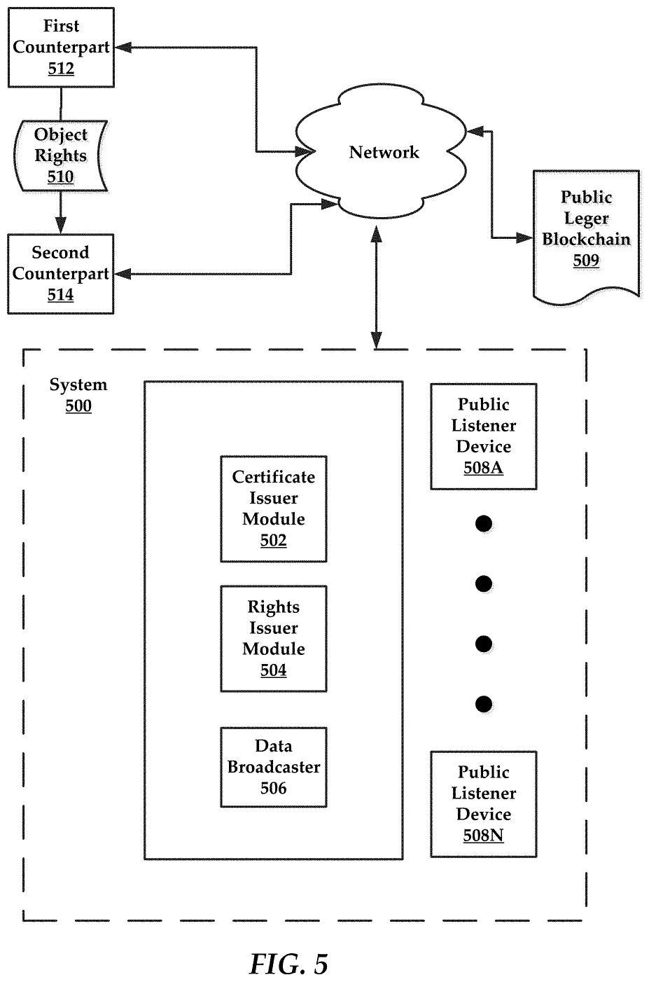

FIG. 5 illustrates an example system 500 of the present disclosure. In general, the system 500 comprises a specific purpose or configured computing system that comprises a certificate issuer module 502 and a rights issuer module 504. The system 500 distributes encrypted transfer records as a byte stream using a data broadcaster 506 as disclosed above with respect to FIG. 3. In some embodiments, a network of public listener devices 508A-N are each configured to receive the byte stream and store the same in a public ledger blockchain 509.

The system 500 facilitates the transfer of ownership rights to an object 510 through the issuance of compliance certificates, creation of transfer transactions, use of smart contracts, and release of encryption/decryption keys based on compliance with smart contract requirements. The transfer of ownership rights to the object 510 occur between a first counterpart 512 and a second counterpart 514, each of which are represented by and interact with the system 500 using end-user computing devices. Methods that are executable within the context of the system 500 are disclosed in greater detail infra.

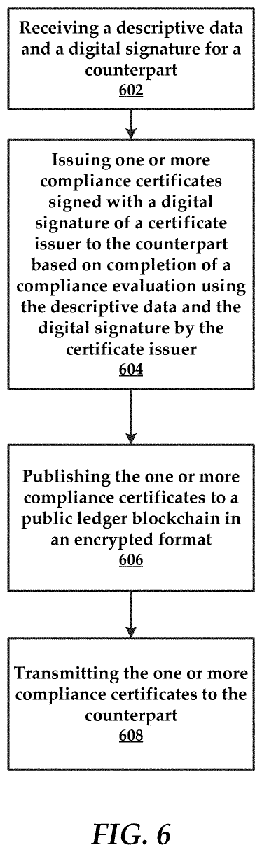

FIG. 6 is a flowchart of an example method of issuing a compliance certificate to a counterpart to a transfer of ownership rights in an object. The method includes a step 602 of receiving a descriptive data and a digital signature for a counterpart. This is descriptive data allows for a KYC/AML analysis to be performed by a certificate issuer. If approved, the method includes a step 604 of issuing one or more compliance certificates signed with a digital signature of a certificate issuer to the counterpart based on completion of a compliance evaluation using the descriptive data and the digital signature by the certificate issuer. That is, the compliance certificate is signed with digital signature of the certificate issuer. The compliance certificate is associated with the digital signature of the counterpart as well so that the can be located at a later point in time. To be sure, each entity or party that desires to transfer of ownership rights in an object using the disclosed method is required to obtain one or more compliance certificates.

In some embodiments, the method includes a step 606 of publishing the one or more compliance certificates to a public ledger blockchain in an encrypted format. The method can also include a step 608 of transmitting the one or more compliance certificates to the counterpart.

Once counterparts have been issued one or more compliance certificates they are considered pre-authorized to perform any authorized transfer of ownership rights in an object.

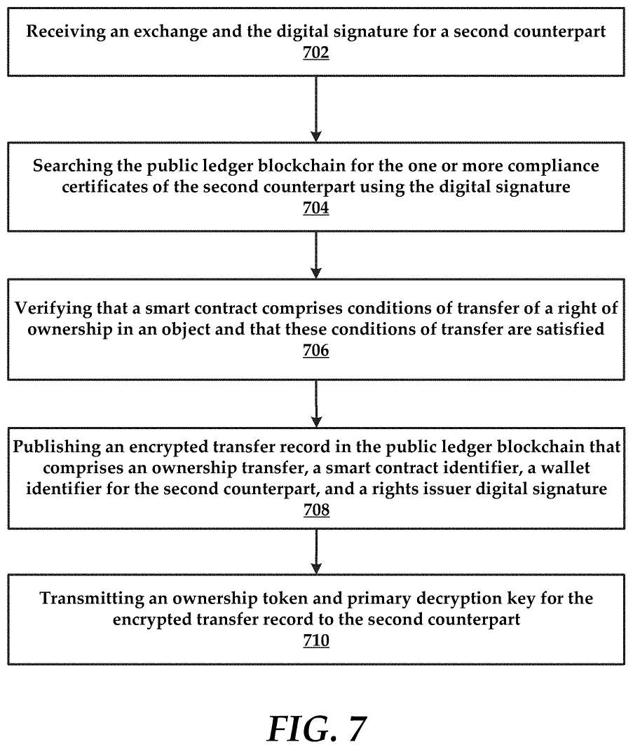

FIG. 7 illustrates an example transfer of ownership rights to an object from a first counterpart to a second counterpart. The method includes a step 702 of receiving an exchange and the digital signature for a second counterpart. Again, the exchange is compensation that is provided to the first counterpart in exchange for transferring rights to an object from the first counterpart to the first counterpart.

In some embodiments, the method includes a step 704 of searching the public ledger blockchain for the one or more compliance certificates of the second counterpart using the digital signature. If one or more compliance certificates are found, the method includes a step 706 of verifying that a smart contract comprises conditions of transfer of a right of ownership in an object and that these conditions of transfer are satisfied. For example, the smart contract defines the compliance certificates that must be possessed by a counterpart before the right of ownership in an object (such as a car title) can be transferred to that counterpart. The smart contract can also comprise general contractual obligations that require satisfaction such as an amount of money to be paid in exchange for the right of ownership.

The method includes a step 708 of publishing an encrypted transfer record in the public ledger blockchain that comprises an ownership transfer, a smart contract identifier, a wallet identifier for the second counterpart, and a rights issuer digital signature. If the requirements of the encrypted transfer record are met, such as meeting the conditions of transfer of the smart contract, the method includes a step 710 of transmitting an ownership token and primary decryption key for the encrypted transfer record to the second counterpart. As noted above, with the primary decryption key, the second counterpart can decrypt the encrypted transfer record using a secondary decryption key found in the encrypted transfer record. Once decrypted the second counterpart is in possession of the ownership right in the object that was initially owned by the first counterpart.

According to some embodiments, a smart contract of the present disclosure can not only be utilized in methods for controlling the transfer of a right to ownership for an object such as a payment right, a decryption key or keys, and so forth, the smart contract can also include other contractual obligations between parties. For example, the smart contract can define not only the types of compliance certificates that must be possessed by a party in order for a right to be transferred to that party, but the smart contract can also define obligations that that party must comply with or complete before receiving possession an object.

In one example, a first party owns a bitcoin address. The bitcoin address can be encrypted and stored in a blockchain ledger. In order for a second party to obtain a right to access the bitcoin address, the second party must comply with specific compliance certificate requirements in a smart contract. When the second party possesses the compliance certificate, the required compliance certificate, the second party is provided with an encryption/decryption key that is used to decrypt the encrypted bitcoin address.

In order to complete the smart contract and take possession of the bitcoin address, the second party is required to comply with other obligations in the smart contract above and beyond the compliance certificate requirements. Thus, while the second party can view and assess the bitcoin address since they are considered a qualified party because they possess the necessary compliance certificates, they are not allowed to possess the bitcoin address until all the obligations of the smart contract are fulfilled.

In one example, the smart contract can allow for features such as installment payments (e.g., payments over time). The installment payments must be made according to the terms set forth in the smart contract before ownership of the bitcoin address can be transferred to the first party. Thus, the first party can allow the second party to pay for the bitcoin address in installment payments before taking possession of the bitcoin address. To be sure, the bitcoin address in this example is merely an example digital asset that can be transferred using obligations stored in a smart contract. In sum, the smart contract can include both compliance certificate requirements and additional contractual obligations that must be met prior to transferring possession of a digital object between parties.

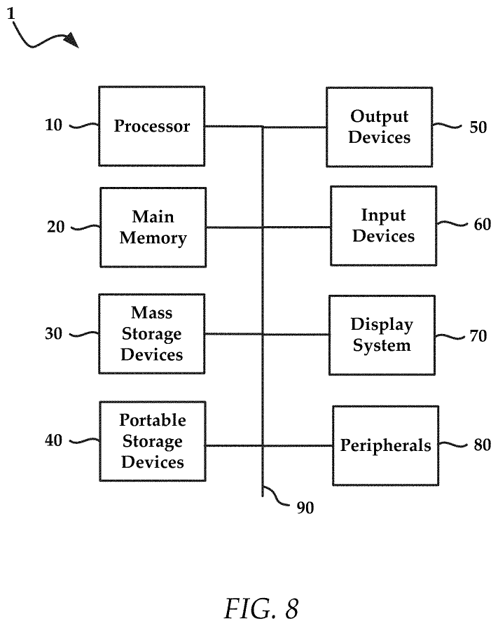

FIG. 8 illustrates an exemplary computing system 1 that may be used to implement an embodiment of the present systems and methods. The computing system 1 of FIG. 8 includes a processor 10 and main memory 20. Main memory 20 stores, in part, instructions and data for execution by processor 10. Main memory 20 may store the executable code when in operation. The computing system 1 of FIG. 8 further includes a mass storage device 30, portable storage device 40, output devices 50, input devices 60, a display system 70, and peripherals 80.

The components shown in FIG. 8 are depicted as being connected via a single bus 90. The components may be connected through one or more data transport means. Processor 10 and main memory 20 may be connected via a local microprocessor bus, and the mass storage device 30, peripherals 80, portable storage device 40, and display system 70 may be connected via one or more input/output (I/O) buses.

Mass storage device 30, which may be implemented with a magnetic disk drive or an optical disk drive, is a non-volatile storage device for storing data and instructions for use by processor 10. Mass storage device 30 can store the system software for implementing embodiments of the present disclosure for purposes of loading that software into main memory 20.

Portable storage device 40 operates in conjunction with a portable non-volatile storage medium, such as a floppy disk, compact disk or digital video disc, to input and output data and code to and from the computing system 1 of FIG. 8. The system software for implementing embodiments of the present disclosure may be stored on such a portable medium and input to the computing system 1 via the portable storage device 40.

Input devices 60 provide a portion of a user interface. Input devices 60 may include an alphanumeric keypad, such as a keyboard, for inputting alphanumeric and other information, or a pointing device, such as a mouse, a trackball, stylus, or cursor direction keys. Additionally, the system 1 as shown in FIG. 8 includes output devices 50. Suitable output devices include speakers, printers, network interfaces, and monitors.

Display system 70 may include a liquid crystal display (LCD) or other suitable display device. Display system 70 receives textual and graphical information, and processes the information for output to the display device.

Peripherals 80 may include any type of computer support device to add additional functionality to the computing system. Peripherals 80 may include a modem or a router.

The components contained in the computing system 1 of FIG. 8 are those typically found in computing systems that may be suitable for use with embodiments of the present disclosure and are intended to represent a broad category of such computer components that are well known in the art. Thus, the computing system 1 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technology in the form disclosed. Many modifications and variations will be apparent to those of ordinary skill in the art without departing from the scope and spirit of the technology. Exemplary embodiments were chosen and described in order to best explain the principles of the present disclosure and its practical application, and to enable others of ordinary skill in the art to understand the technology for various embodiments with various modifications as are suited to the particular use contemplated.

Aspects of the present disclosure are described above with reference to flowchart illustrations and/or block diagrams of methods, apparatus (systems) and computer program products according to embodiments of the technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

While the present disclosure has been described in connection with a series of preferred embodiment, these descriptions are not intended to limit the scope of the technology to the particular forms set forth herein. It will be further understood that the methods of the technology are not necessarily limited to the discrete steps or the order of the steps described. To the contrary, the present descriptions are intended to cover such alternatives, modifications, and equivalents as may be included within the spirit and scope of the technology as defined by the appended claims and otherwise appreciated by one of ordinary skill in the art.

What is claimed is:

1. A method, comprising:
receiving a descriptive data and a digital signature for each of a first counterpart and a second counterpart;
issuing one or more compliance certificates signed with a digital signature of a certificate issuer to each of the first counterpart and the second counterpart based on completion of a compliance evaluation using the descriptive data and the digital signature by the certificate issuer; and
publishing the one or more compliance certificates to a public ledger blockchain in an encrypted format.

2. The method according to claim 1, further comprising:
receiving an exchange and a digital signature for the second counterpart;
searching the public ledger blockchain for the one or more compliance certificates of the second counterpart using the digital signature;
verifying that a smart contract comprises conditions of transfer rights in an object of the first counterpart;
publishing an encrypted transfer record in the public ledger blockchain that comprises an ownership transfer, a smart contract identifier, a wallet identifier for the second counterpart, and a rights issuer digital signature; and
transmitting an ownership token and a primary decryption key for the encrypted transfer record to the second counterpart, the second counterpart using the primary decryption key and a secondary decryption key to decrypt the encrypted transfer record and obtain the rights in the object.

3. The method according to claim 2, wherein the compliance certificate is digitally signed by a certificate issuer that generated the compliance certificate.

4. The method according to claim 3, further comprising publishing a digital signature of the certificate issuer and a certificate identifier for each of the one or more compliance certificates of the first counterpart and the second counterpart to the public ledger blockchain.

5. The method according to claim 4, further comprising storing the secondary decryption key for the encrypted transfer record in the public ledger blockchain.

6. The method according to claim 5, further comprising:
verifying the transfer of the rights in the object using a smart contract; and
providing the primary decryption key to the second counterpart when the conditions of transfer of the smart contract are met by the second counterpart.

7. The method according to claim 6, wherein the conditions of transfer of the smart contract comprise the second counterpart having one or more required compliance certificates.

8. The method according to claim 7, wherein the smart contract comprises contractual obligations established by the first counterpart.

9. The method according to claim 8, wherein an ownership token allows the second counterpart to view contents of the encrypted block stored in the public ledger blockchain.

10. The method according to claim 9, further comprising generating the ownership token and transmitting the ownership token to the first counterpart or the second counterpart.

11. A system, comprising:
a data broadcaster configured to:
publish an encrypted transfer record to a public ledger blockchain, the encrypted transfer record comprising a secondary decryption key for a message stored in the public ledger blockchain and a right of ownership in an object;
a rights issuer configured to:
transmit an ownership token and a primary decryption key for the encrypted transfer record to a second counterpart if conditions of transfer of a smart contract referenced by the encrypted transfer record are satisfied; and
a network of public listener devices each configured to:
receive the encrypted transfer record as a byte stream of values; and
store the encrypted transfer record in the public ledger blockchain.

12. The system according to claim 11, wherein the rights issuer is further configured to:
receive the ownership token and a digital signature from the second counterpart;
authenticate the second counterpart based on one or more compliance certificates for the second counterpart found in the public ledger blockchain using the digital signature of the second counterpart; and
if the second counterpart is authenticated, execute a smart contract so as to release the primary decryption key to the second counterpart, the second counterpart using the primary decryption key and a secondary decryption key to decrypt the encrypted transfer record and obtain the right of ownership in the object.

13. The system according to claim 11, wherein the public ledger blockchain is configured with variable-length or fixed-length storage.

14. The system according to claim 13, wherein the encrypted transfer record comprises a record terminator that comprises a record identifier and a record offset and length.

15. The system according to claim 14, wherein the record length is utilized to validate integrity of the encrypted transfer record.

16. The system according to claim 15, further comprising a certificate issuer configured to:
receive descriptive data and a digital signature for each of a first counterpart and the second counterpart;
issue one or more compliance certificates signed with a digital signature of a certificate issuer to the first counterpart and the second counterpart based on completion of a compliance evaluation using the descriptive data and the digital signature by the certificate issuer;
receive an exchange and the digital signature for the second counterpart;
search the public ledger blockchain for the one or more compliance certificates of the second counterpart using the digital signature so as to authenticate the second counterpart;
verify conditions of transfer of a right in a smart contract are satisfied, the conditions of transfer comprising issuance of the one or more compliance certificates to the second counterpart; and
release a primary decryption key to the second counterpart that is used with the secondary decryption key found in the encrypted transfer record to receive the ownership right.

17. The system according to claim 16, wherein the encrypted transfer record comprises a record checksum that comprises a tokenized representation of content included in the encrypted transfer record.
